(19) United States
(12) Patent Application Publication
(10) Pub. No.: US 2024/0310519 A1
(43) Pub. Date: Sep. 19, 2024

(54) DISTANCE MEASURING APPARATUS

(71) Applicant: Mitsubishi Electric Corporation, Tokyo (JP)

(72) Inventors: Natsuki HONDA, Tokyo (JP); Masayuki OMAKI, Tokyo (JP); Shota NAKAHARA, Tokyo (JP)

(73) Assignee: Mitsubishi Electric Corporation, Tokyo (JP)

(21) Appl. No.: 18/578,016

(22) PCT Filed: Jul. 30, 2021
(86) PCT No.: PCT/JP2021/028256

§ 371 Date: Jan. 10, 2024

(51) Int. Cl. G01S 17/08; G01S 7/481

(52) U.S. Cl. CPC G01S 17/08; G01S 7/4814; G01S 7/4817

(57) ABSTRACT

The distance measuring apparatus detects return light reflected off or scattered by an object and measures a distance to the object. The distance measuring apparatus includes a laser light source, an optical scanning unit to scan with outgoing light emitted from the laser light source, a light receiving unit to detect the return light, which is reflected off the object irradiated with the outgoing light from the optical scanning unit, reflected off the optical scanning unit, a light-path guiding unit to direct the outgoing light emitted from the laser light source toward the optical scanning unit, and a first aperture to make a diameter of the outgoing light small and disposed on an optical path, from the laser light source to the light-path guiding unit, of the outgoing light.

### TECHNICAL FIELD

The present disclosure relates to a distance measuring apparatus.

### BACKGROUND ART

A distance measuring apparatus irradiates a target area with laser light and detects the presence or absence of an object on the basis of the presence or absence of return light reflected off or scattered by the target area. Also, the distance measuring apparatus detects a distance to an object on the basis of the time required from the timing of laser light irradiation to the timing of return light reception. See, for example, Patent Reference 1.

In the apparatus of Patent Reference 1, a part of the optical axis of a transmitting optic that irradiates laser light is aligned with a part of the optical axis of a light receiver that receives return light, in order to extend a measurable distance. Also, the apparatus of Patent Reference 1 includes an optical splitter that splits the optical path of the laser light and the optical path of the return light. The optical splitter of Patent Reference 1 is a perforated mirror that transmits the laser light.

### PRIOR ART REFERENCE

### Patent Reference

Patent Reference 1: Japanese Unexamined Patent Application Publication (Translation of PCT Application) No. 2020-531841

### SUMMARY OF THE INVENTION

### Problem to be Solved by the Invention

However, in Patent Reference 1, when the aperture of the optical splitter is made smaller to increase the receiving amount of the return light, the laser light is scattered or diffracted on the inner surface (hereafter, also referred to as an “edge”) surrounding the aperture. In this case, the spot diameter of the laser light becomes larger, and thus the resolving power of the range and bearing is reduced. Also, if the scattered light and diffracted light formed by the laser light passing through the aperture is incident on the light receiver as stray light, a measurable distance is shortened because it is difficult for the light receiver to distinguish between the stray light and the return light.

It is an object of the present disclosure to improve the resolving power of the range and bearing and extend the measurable distance.

### Means of Solving the Problem

A distance measuring apparatus according to an aspect of the present disclosure is a distance measuring apparatus to detect return light reflected off or scattered by an object and measure a distance to the object. The distance measuring apparatus includes: a laser light source; an optical scanning unit to scan with outgoing light emitted from the laser light source; a light receiving unit to detect the return light reflected off the optical scanning unit, the return light being reflected off the object irradiated with the outgoing light from the optical scanning unit; a light-path guiding unit to direct the outgoing light emitted from the laser light source toward the optical scanning unit; and a first aperture unit to make a diameter of the outgoing light small and disposed on an optical path, from the laser light source to the light-path guiding unit, of the outgoing light.

### EFFECTS OF THE INVENTION

According to the present disclosure, resolving power of a range and bearing can be improved and a measurable distance can be extended.

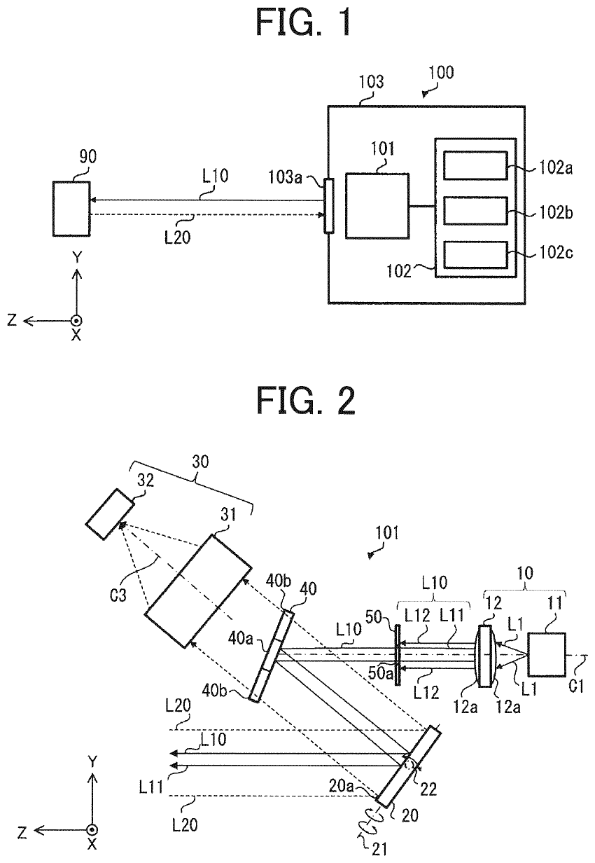

FIG. 1 is a configuration diagram showing a schematic configuration of a distance measuring apparatus according to an embodiment and an object.

FIG. 2 is a configuration diagram showing a schematic configuration of an optical scanner shown in FIG. 1.

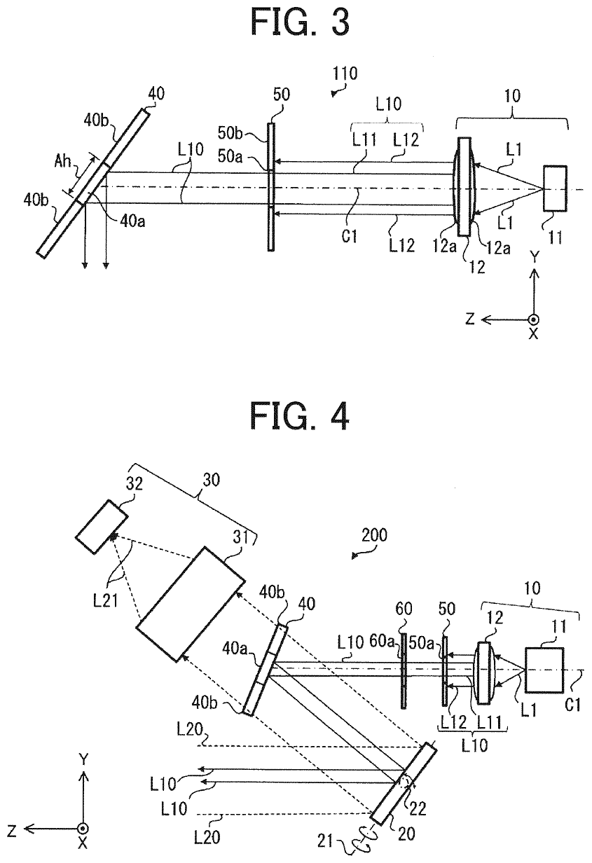

FIG. 3 is a diagram showing a configuration around an aperture unit shown in FIG. 2.

FIG. 4 is a configuration diagram of a distance measuring apparatus according to a first modification of the embodiment.

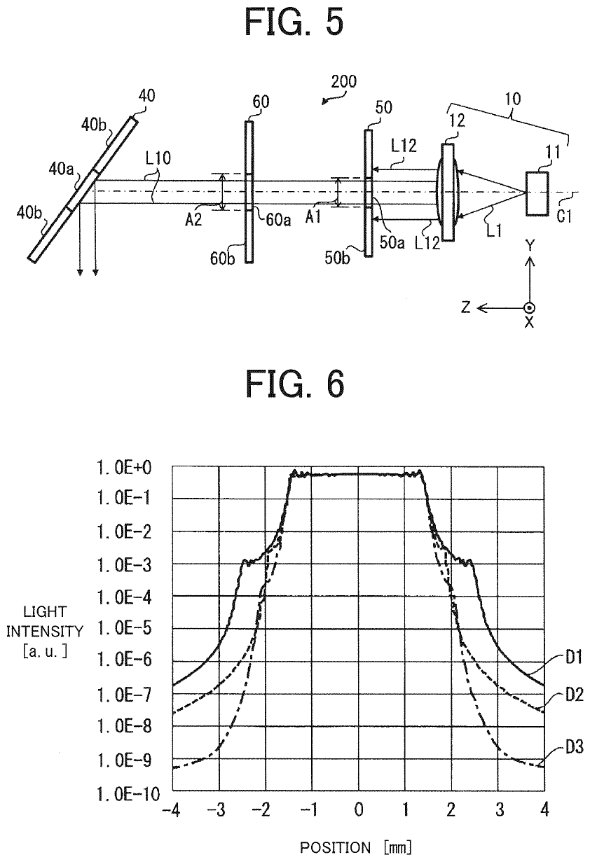

FIG. 5 is a diagram showing a configuration around a first aperture unit and a second aperture unit shown in FIG. 4.

FIG. 6 is a graph showing light intensity distribution of outgoing light in which diffraction occurs.

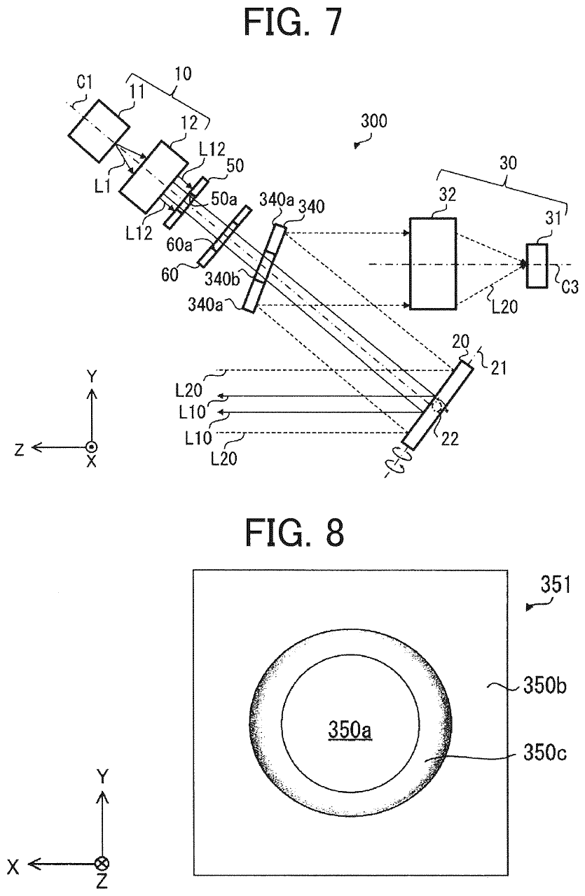

FIG. 7 is a configuration diagram showing a schematic configuration of a distance measuring apparatus according to a second modification of the embodiment.

FIG. 8 is a diagram showing a first aperture unit of a distance measuring apparatus according to a second modification of the embodiment as another example, as seen in the Z-axis direction.

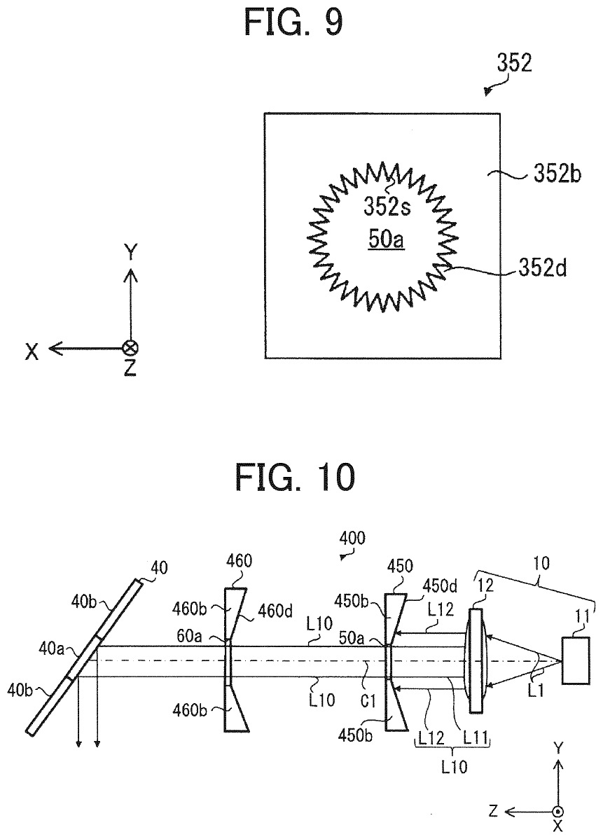

FIG. 9 is a diagram showing a first aperture unit of the distance measuring apparatus according to the second modification of the embodiment as still another example, as seen in the Z-axis direction.

FIG. 10 is a configuration diagram showing a schematic configuration of a distance measuring apparatus according to a third modification of the embodiment.

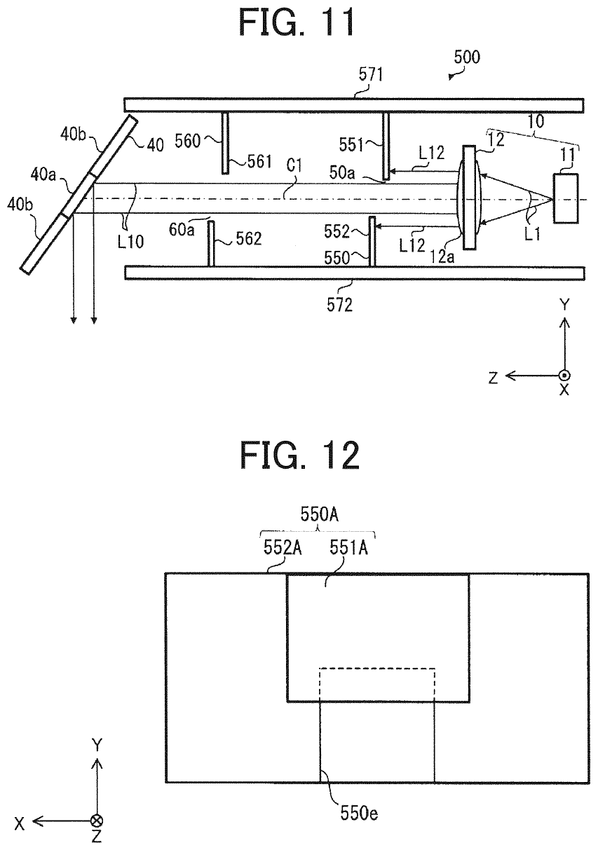

FIG. 11 is a configuration diagram showing a part of a schematic configuration of a distance measuring apparatus according to fourth modification of the embodiment.

FIG. 12 is a diagram showing a first aperture unit of the distance measuring apparatus according to the fourth modification of the embodiment as another example, as seen in the Z-axis direction.

### MODE FOR CARRYING OUT THE INVENTION

A distance measuring apparatus according to an embodiment of the present disclosure will now be described below with reference to the attached drawings. The following embodiment is merely an example, and the embodiment and modifications may be combined as appropriate and the embodiment and each modification may be modified as appropriate.

In order to facilitate understanding of the description, the drawings show the coordinate axes of an XYZ orthogonal coordinate system. The Z-axis is the coordinate axis parallel to a direction in which outgoing light, which emerges from the distance measuring apparatus toward an object, travels. The X-axis is the coordinate axis perpendicular to the Z-axis. The Y-axis is the coordinate axis perpendicular to the X-axis and the Z-axis.

### Embodiment

### Configuration of Distance Measuring Apparatus 100

FIG. 1 is a diagram showing a schematic configuration of the distance measuring apparatus 100 according to the embodiment and an object 90. The distance measuring apparatus 100 detects the distance to the object 90 by detecting return light L20 that is reflected off or scattered by the object 90 irradiated with the outgoing light L10. The distance measuring apparatus 100 irradiates the object 90 with, for example, a single-mode laser beam or a multimode laser beam as the outgoing light L10. It should be noted that the distance measuring apparatus 100 may detect the distance to multiple objects 90. That is, the distance measuring apparatus 100 can detect the distance to at least one object 90.

The distance measuring apparatus 100 includes an outgoing light scanner (hereafter also referred to as an “optical scanner”) 101, a computer 102, and a housing 103.

### Configuration of Optical Scanner 101

FIG. 2 is a configuration diagram showing a schematic configuration of the optical scanner 101 shown in FIG. 1. As shown in FIG. 2, the optical scanner 101 includes a laser light source 10, a scanning mirror 20 as an optical scanning unit, a light receiver 30 as a light receiving unit, and an optical splitter 40 as a light-path guiding unit.

The laser light source 10 includes a light source 11 and a transmitting optic 12. In the description hereafter, the optical axis of the laser light source 10 is referred to as an “optical axis C1.”

The light source 11 emits laser light L1. The light source 11 is, for example, a semiconductor laser light source. The output of the light source 11 is, for example, 10 W or more.

The transmitting optic 12 collimates the laser light L1 emitted from the light source 11. In other words, the transmitting optic 12 is an optical unit that converts the laser light L1 into collimated beams and emits the collimated beams as outgoing light L10. The transmitting optic 12 includes, for example, a convex lens 12a. “Collimating” means collimating the laser light L1. The collimated beams collimated by the transmitting optic 12 have a spread angle, which is, for example, in the range from zero degrees to two degrees.

In the present embodiment, the optical splitter 40 is an optical component that distinguishes between the optical path of the outgoing light L10 and the optical path of the return light L20. When the optical axis of the light receiver 30 is an optical axis C3, the optical splitter 40 is rotated about the X axis and inclined with respect to a plane perpendicular to the optical axis C3. In the example shown in FIG. 2, the optical splitter 40 reflects the outgoing light L10 and transmits the return light L20. Specifically, the optical splitter 40 includes a reflecting portion 40a and a transmitting portion 40b.

The reflecting portion 40a reflects the outgoing light L10, which emerges from the transmitting optic 12 and then passes through the aperture unit 50 described later, and directs the outgoing light L10 to the scanning mirror 20. The shape of the reflecting portion 40a is, for example, circular. It should be noted that the shape of the reflecting portion 40a is not limited to a circular shape, but may be other shapes such as an ellipse or a rectangle.

The transmitting portion 40b transmits the return light L20 reflected off the scanning mirror 20 and directs the return light L20 to the light receiver 30. The optical splitter 40 is formed, for example, by coating transparent glass with a reflecting film as the reflecting portion 40a. It should be noted that the optical splitter 40 can be achieved without the transmitting portion 40b. The optical splitter 40 may, for example, be a micro-mirror including only the reflecting portion 40a. In this case, the return light L20 reflected off the scanning mirror 20 passes through the outside of the optical splitter 40 and is then incident on the light receiver 30.

The scanning mirror 20 performs scanning with the outgoing light L10 reflected off the optical splitter 40. The scanning mirror 20 reflects the outgoing light L10 and directs the outgoing light L10 to the object 90 (see FIG. 1). The scanning mirror 20 rotates about two rotation axes 21 and 22. Accordingly, the scanning mirror 20 changes the outgoing direction of the outgoing light L10 and directs the outgoing light L10 toward the object 90. The two rotation axes 21 and 22 are parallel to a plane perpendicular to the normal to a reflecting surface 20a of the scanning mirror 20 and perpendicular to each other. The scanning mirror 20 performs scanning with the outgoing light L10 in two dimensions. The scanning mirror 20 is, for example, a Micro Electro Mechanical Systems (MEMS) mirror. The scanning mirror 20 performs scanning with the outgoing light L10, and then a light scanning area where the object 90 is located is irradiated with the outgoing light L10.

The light receiver 30 detects the return light L20 reflected off the scanning mirror 20. In an example shown in FIG. 2, the light receiver 30 includes a condensing optic 31 and a light receiving element 32.

The condensing optic 31 is disposed on the optical path of the return light L20 transmitted through the optical splitter 40. The condensing optic 31 condenses the return light L20 transmitted through the optical splitter 40 and directs the return light L20 to the light receiving element 32. Accordingly, the accuracy of detecting the return light L20 at the light receiving element 32 can be improved. The condensing optic 31 includes, for example, a condensing lens.

The light receiving element 32 detects the return light L20. The light receiving element 32 is, for example, a Silicon Photo Multiplier (SiPM) or a photodiode such as an Avalanche Photo Diode (APD) or single-photon APD. Since APD, single-photon APD, and SiPM have high sensitivity, the return light L20 can be detected even when the object 90 (see FIG. 1) is located at a distance from the distance measuring apparatus 100 and the reflectance of the object 90 is low. Accordingly, the distance measurable by the distance measuring apparatus 100 is increased and consequently the distance measuring apparatus 100 can acquire an accurate distance image of the object 90 over a wider area.

The optical scanner 101 further includes an aperture unit 50 (hereafter, also referred to as a “first aperture unit 50”).

FIG. 3 is a diagram showing the configuration around the aperture unit 50 of the optical scanner 101 shown in FIG. 2. The laser light source 10, the aperture unit 50, and the optical splitter 40 form an optical transmission system 110 of the optical scanner 101. The aperture unit 50 is disposed on the optical path, from the laser light source 10 to the optical splitter 40, of the outgoing light L10. The aperture unit 50 makes the diameter of the outgoing light L10 emerging from the transmitting optic 12 small.

The aperture unit 50 includes an opening 50a as a first light-passing portion (hereafter, also referred to as a “first opening 50a”). The opening 50a is smaller than the diameter of the outgoing light L10. The opening 50a allows part, which includes the center light flux L11, of the outgoing light L10 to pass. The center light flux L11 is light flux including the center ray of the outgoing light L10. Also, the center light flux L11 is light flux that travels on the optical axis C1 and in the region near the optical axis C1 of the outgoing light L10. The center light flux L11 may include rays that travel parallel to the optical axis C1 and rays that travel non-parallel to the optical axis C1 in the region near the optical axis C1.

It is preferable that the opening 50a be smaller than the diameter Ah of the reflecting portion 40a of the optical splitter 40. The opening 50a is, for example, circular. It should be noted that the opening 50a is not limited to a circular shape, but may have other shapes such as an oval or a rectangle.

The aperture unit 50 further includes a light blocker 50b as a first light blocker disposed outside the opening 50a. Accordingly, neighboring rays L12, which travel away from the optical axis C1, of the outgoing light L10 can be blocked. Thus, the diameter of the outgoing light L10 incident on the optical splitter 40 can be reduced.

The advantages of the distance measuring apparatus 100 provided with the aperture unit 50 will now be described. As described above, the optical splitter 40 includes the reflecting portion 40a that directs the outgoing light L10 to the scanning mirror 20. In order to increase a measurable distance, the area of the reflecting portion 40a should be small. In other words, to increase the measurable distance, the diameter of the outgoing light L10 incident on the optical splitter 40 (hereafter, also referred to as “beam diameter”) should be reduced.

In order to reduce the beam diameter of the outgoing light L10, it is contemplated to shorten the focal length of the convex lens 12a of the transmitting optic 12. However, in this method, the spread angle of the outgoing light L10 (i.e., divergence angle) becomes large and consequently measuring resolution deteriorates. In order to reduce the beam diameter and suppress the spread angle of the outgoing light L10, the distance measuring apparatus 100 according to the present embodiment includes the aperture unit 50 shown in FIG. 2 and FIG. 3.

Also, in the distance measuring apparatus 100 according to the present embodiment, the optical splitter 40 is disposed within the field of view of the light receiver 30. In other words, the optical splitter 40 is disposed on the optical path, from the scanning mirror 20 to the light receiver 30, of the return light L20. For that reason, if a portion of the outgoing light L10 is not reflected off the reflecting portion 40a of the optical splitter 40, stray light that is incident on the light receiving element 32 is generated. Therefore, if the reflecting portion 40a of the optical splitter 40 is used as an aperture unit to limit the beam diameter, a large amount of stray light may be generated. As described above, one example of the light receiving element 32 is an element with high sensitivity to light, such as an APD or an SiPM. For that reason, since the light receiving element 32 detects even light as weak as a few pW, the accuracy of measuring deteriorates if stray light is generated. For example, in the case where the distance to the object 90 close to the distance measuring apparatus 100 is measured, if stray light is generated, it is difficult to distinguish between the stray light and the return light L20 in the light receiving element 32. For that reason, the distance that can be measured to the object 90 is reduced.

The aperture unit 50 makes the beam diameter of the outgoing light L10 at the time of entering the optical splitter 40 smaller than the beam diameter of the outgoing light L10 at the time of being emitted from the laser light source 10. Accordingly, the resolving power of the range and bearing in the distance measuring apparatus 100 is improved and the measurable distance can be extended. Also, the distance measuring apparatus 100 according to the present embodiment can improve the resolving power of the range and bearing with a low-cost and compact configuration without increasing the thickness of the transmitting optic 12 in the Z-axis direction.

### Configuration of Computer 102

Returning to FIG. 1, the configuration of the computer 102 and the housing 103 will now be described. The computer 102 includes a controller 102a as a control unit, an arithmetic unit 102b, and a storage unit 102c. The controller 102a and the arithmetic unit 102b are provided in a processor such as a Central Processing Unit (CPU), a Graphics Processing Unit (GPU), and a Field-Programmable Gate Array (FPGA). The storage unit 102c is, for example, a Read On Memory (ROM) or a hard disk.

The controller 102a is communicatively connected to the light source 11, the scanning mirror 20, and the light receiving element 32. The controller 102a controls the optical scanner 101. The details of the control by the controller 102a are described later.

The arithmetic unit 102b generates a distance image. The distance image generated by the arithmetic unit 102b includes the distance between the distance measuring apparatus 100 and the object 90 and the direction in which the distance measuring apparatus 100 views the object 90. The arithmetic unit 102b outputs a signal about the distance image to a display not shown. The display is communicatively connected to the computer 102 (e.g., storage unit 102c). The display displays the distance image.

### Configuration of Housing 103

The housing 103 houses the optical scanner 101 and the computer 102. The housing 103 includes a transparent window 103a. The transparent window 103a transmits the outgoing light L10 emitted from the optical scanner 101 and the return light L20 reflected off or scattered by the object 90. It should be noted that the transparent window 103a may be formed of a wavelength filter having a wavelength different from each wavelength of the outgoing light L10 and the return light L20. Accordingly, unnecessary light can be blocked. Also, in the distance measuring apparatus 100, the computer 102 can be achieved without being housed in the housing 103. In this case, the computer 102 may be disposed outside the housing 103.

### Control by Controller 102a

Next, the control by the controller 102a shown in FIG. 1 will now be described. The controller 102a controls the light source 11. Accordingly, the outgoing timing of the laser light L1 is controlled. The controller 102a receives a signal, which indicates the time when the light source 11 emitted the laser light L1 (hereafter, also referred to as “first timing”), from the light source 11.

Also, the controller 102a controls the scanning mirror 20. The controller 102a receives a signal, which indicates the tilt angle of the scanning mirror 20 (e.g., the tilt of the normal of the reflecting surface 20a of the scanning mirror 20), from the scanning mirror 20. Also, the controller 102a receives a signal, which indicates the amount of return light L20 received by the light receiving element 32, from the light receiving element 32. In addition, the controller 102a also receives a signal, which indicates the time at which the light receiving element 32 detected the return light L20 (hereafter, also referred to as “second timing”), from the light receiving element 32.

The arithmetic unit 102b calculates the outgoing direction of the outgoing light L10 on the basis of the tilt of the scanning mirror 20 received by the controller 102a and the position of the light source 11 relative to the scanning mirror 20 stored in advance in the storage unit 102c.

Also, the arithmetic unit 102b receives a signal indicating the first timing and another signal indicating the second timing, from the controller 102a. The arithmetic unit 102b calculates the distance between the distance measuring apparatus 100 and the object 90 and the position of the object 90 relative to the distance measuring apparatus 100 on the basis of the calculated outgoing direction of the outgoing light L10, the first timing, and the second timing.

### Advantages of Present Embodiment

According to the present embodiment described above, the distance measuring apparatus 100 includes the aperture unit 50. The aperture unit 50 is disposed on the optical path, from the laser light source 10 to the reflecting portion 40a of the optical splitter 40, of the outgoing light L10 and makes the diameter of the outgoing light L10 small. Accordingly, scattering and diffraction for the case where the outgoing light L10 is incident on the optical splitter 40 is prevented, thereby improving the resolving power of the range and bearing. Also, since scattered light and diffracted light of the outgoing light L10 are prevented from being incident on the light receiver 30 as stray light, the measurable distance can be extended. Therefore, the distance measuring apparatus 100 according to the present embodiment can improve the resolving power of the range and bearing and increase the measurable distance.

Also, according to the present embodiment, the aperture unit 50 includes the opening 50a, which transmits part including the center light flux of the outgoing light L10, and the light blocker 50b disposed outside the opening 50a. Accordingly, the neighboring rays L12, which travel through positions away from the optical axis C1, of the outgoing light L10 can be blocked. Therefore, the aperture unit 50 can make the diameter of the outgoing light L10 at the time of entering the optical splitter 40 small.

### First Modification of Embodiment

FIG. 4 is a configuration diagram of a distance measuring apparatus 200 according to a first modification of the embodiment. In FIG. 4, each component identical or corresponding to a component shown in FIG. 2 is assigned the same reference sign as those in FIG. 2. The distance measuring apparatus 200 according to the first modification of the embodiment differs from the distance measuring apparatus 100 according to the embodiment in that the distance measuring apparatus 200 further includes a second aperture unit 60. Other than this, the distance measuring apparatus 200 according to the first modification of the embodiment is the same as the distance measuring apparatus 100 according to the embodiment.

As shown in FIG. 4, the distance measuring apparatus 200 includes the laser light source 10, the scanning mirror 20, the light receiver 30, an optical splitter 40, the first aperture unit 50, and a second aperture unit 60.

The second aperture unit 60 is disposed on the optical path, from the first aperture unit 50 to the optical splitter 40, of the outgoing light L10.

FIG. 5 is a diagram showing a configuration around the first aperture unit 50 and the second aperture unit 60 shown in FIG. 4. As shown in FIG. 4 and FIG. 5, the second aperture unit 60 includes a second opening 60a as a second light-passing portion and a second light blocker 60b disposed outside the second opening 60a.

The opening width A2 of the second opening 60a is larger than the opening width A1 of the first opening 50a. When the neighboring rays L12 of the outgoing light L10 emitted from the laser light source 10 are blocked by the first aperture unit 50, the light intensity distribution of the outgoing light L10 passing through the first opening 50a is affected by Fresnel diffraction. The opening width A2 is larger than the opening width A1, thereby blocking the diffracted light of the outgoing light L10 caused by passing through the first opening 50a.

Also, the opening width A2 is smaller than the diameter Ah of the reflecting portion 40a of the optical splitter 40 (see, FIG. 3). The second opening 60a is, for example, circular. It should be noted that the second opening 60a is not limited to a circular shape, but may be other shapes such as an oval or the rectangle described above.

It is preferable that the thickness of each of the first aperture unit 50 and the second aperture unit 60 in the Z-axis direction be, for example, 2.0 mm or less. Accordingly, diffraction in the case where the outgoing light L10 passes through the first opening 50a and the second opening 60a respectively can be suppressed.

Also, it is preferable that the first aperture unit 50 and the second aperture unit 60 be apart from each other. It is preferable that the distance between the first aperture unit 50 and the second aperture unit 60 be 1.0 mm or more. In an example shown in FIG. 5, for example, the distance between the first aperture unit 50 and the second aperture unit 60 is 15 mm.

FIG. 6 is a graph showing the light intensity distribution D1, D2, and D3 of the outgoing light L10. In FIG. 6, the horizontal axis indicates the position where the light intensity is measured [mm], and the vertical axis indicates the light intensity [a.u.].

The light intensity distribution D1 is the light intensity distribution of the outgoing light L10 measured on the optical splitter 40 when the first opening 50a is a rectangular shape of 3.0 mm×3.0 mm and the distance between the first aperture unit 50 and the optical splitter 40 is 35 mm. When the light intensity distribution D1 is measured, the wavelength of the outgoing light L10 is 905 nm, and the outgoing light L10 emitted from the light source 11 is collimated by the transmitting optic 12. In the embodiment described above, the second aperture unit 60 is not provided. For that reason, the light intensity distribution D1 spreads outward from the position corresponding to the outer edge of the first opening 50a on the optical splitter 40 (i.e., +1.5 mm) because of diffraction generated when the outgoing light L10 passes through the first opening 50a. In this case, the outgoing light L10 leaks from the reflecting portion 40a when being incident on the optical splitter 40, thereby becoming stray light.

Light intensity distribution D2 is the light intensity distribution at a position 15 mm away from the first aperture unit 50 in the +Z-axis direction (i.e., in the outgoing direction of the outgoing light L10). Light intensity distribution D3 is the light intensity distribution of the outgoing light L10 measured on the optical splitter 40 when the second aperture unit 60 is disposed 15 mm away from the first aperture unit 50 in the +Z-axis direction and the second opening 60a is a rectangular shape of 3.1 mm×3.1 mm. In the light intensity distribution D3, the light intensity in the region outside the position corresponding to the outer edge of the first opening 50a on the optical splitter 40 (i.e., +1.5 mm) is smaller than in the light intensity distribution D1. Thus, providing the second aperture unit 60 including the second opening 60a larger than the first opening 50a allows the diffracted light generated when the outgoing light L10 passes through the first opening 50a to be incident on the optical splitter 40 as stray light. It should be noted that even if the light intensity distribution of the outgoing light L10 has other shapes such as a Gaussian shape, the same tendency described above is observed.

When the outgoing light L10 of a plane wave passes through the opening given by the aperture function f (x, y), the amplitude distribution u (x′, y′) at a distance R away in the +Z-axis direction from the opening is expressed by the following Equation (1).

$$u ( {x}^{′} , {y}^{′} ) = \frac{A}{i λ} \int \int \frac{f ( x , y )}{R} exp ( ik \sqrt{{R}^{2} + {( x - {x}^{′} )}^{2} + {( y - {y}^{′} )}^{2}} ) dxdy \qquad ( 1 )$$

In Equation (1), A is the amplitude, i is the imaginary unit, k is the wavenumber, (x, y) are the coordinates on the opening, and (x′, y′) is the coordinate at a distance R from the opening. It is preferable that the second aperture unit 60 be disposed at the position for the case where the value of the left side of Equation (1) is ⅕ or less of the peak intensity of the outgoing light L10.

Also, when the distance measuring apparatus 200 is viewed in the Y-axis direction, the second aperture unit 60 is disposed at a position where the second aperture unit 60 and the return light L20 reflected off the scanning mirror 20 do not overlap each other. Accordingly, the return light L20 can be prevented from being blocked by the second aperture unit 60.

### Advantages of First Modification of Embodiment

According to the first modification of the embodiment described above, the distance measuring apparatus 200 includes the first aperture unit 50 disposed on the optical path, from the laser light source 10 to the reflecting portion 40a of the optical splitter 40, of the outgoing light L10, and the distance measuring apparatus 200 makes the diameter of the outgoing light L10 small. Accordingly, scattering and diffraction for the case where the outgoing light L10 is incident on the optical splitter 40 is prevented, thereby improving the resolving power of the range and bearing. Also, since scattered light and diffracted light of the outgoing light L10 are prevented from being incident on the light receiver 30 as stray light, the measurable distance can be extended. Therefore, the distance measuring apparatus 200 can improve the resolving power of the range and bearing and increase the measurable distance.

In addition, according to the first modification of the embodiment, the distance measuring apparatus 200 further includes the second aperture unit 60 disposed on the optical path from the first aperture unit 50 to the optical splitter 40, and the second opening 60a of the second aperture unit 60 is larger than the first opening 50a of the first aperture unit 50. Accordingly, the diffracted light of the outgoing light L10 caused by passing through the first opening 50a can be blocked by the second aperture unit 60. Therefore, the distance measuring apparatus 200 according to the first modification of the embodiment can further improve the resolving power of the range and bearing and further increase the measurable distance.

### Second Modification of Embodiment

In the examples of the embodiment and the first modification of the embodiment described above, the outgoing light L10 emitted from the laser light source 10 is reflected off the optical splitter 40 and is then directed to the scanning mirror 20, and the return light L20 passes through the optical splitter 40 and is then incident on the light receiver 30. In an example of a second modification of the embodiment, the outgoing light L10 emitted from the laser light source 10 passes through an optical splitter 340 and is then directed to the scanning mirror 20, and the return light L20 is reflected off the optical splitter 40 and is then incident on the light receiver 30. FIG. 7 is a configuration diagram showing a schematic configuration of a distance measuring apparatus 300 according to the second modification of the embodiment. In FIG. 7, each component identical or corresponding to a component shown in FIG. 2 or FIG. 4 is assigned the same reference sign as those in FIG. 2. or FIG. 4.

As shown in FIG. 7, the distance measuring apparatus 300 includes the laser light source 10, the scanning mirror 20, the light receiver 30, the optical splitter 340, the first aperture unit 50, and the second aperture unit 60.

The optical splitter 340 includes a reflecting portion 340a and a transmitting portion 340b.

The reflecting portion 340a reflects the return light L20 reflected off the scanning mirror 20 and directs the return light L20 to the light receiver 30. Thus, in the second modification of the embodiment, the return light L20 reflected off the scanning mirror 20 is reflected off the optical splitter 40 and is then incident on the light receiver 30.

The transmitting portion 340b transmits the outgoing light L10 emerging from the transmitting optic 12 and directs the outgoing light L10 to the scanning mirror 20. The transmitting portion 340b is, for example, a through hole passing through the optical splitter 340. That is, the optical splitter 340 is, for example, a perforated mirror. It should be noted that the optical splitter 340 may be a reflecting mirror made of transparent glass coated with a reflecting film as the reflecting portion 340a. Also, the optical splitter 340 can be achieved without the transmitting portion 340b.

If the first aperture unit 50 and the second aperture unit 60 are not included in the distance measuring apparatus 300, the outgoing light L10 incident on the optical splitter 340 may be scattered by the inner surface (i.e., edge) of the through hole that is the transmitting portion 340b and be generated scattered light. Also, diffracted light may be generated when the outgoing light L10 passes through the through hole. The scattered light and the diffracted light are incident on the light receiver 30 as stray light.

In the second modification of the embodiment, the first aperture unit 50 is disposed on the optical path, from the laser light source 10 to the optical splitter 340, of the outgoing light L10 and makes the diameter of the outgoing light L10 small. Accordingly, scattering and diffraction for the case where the outgoing light L10 is incident on the optical splitter 340 is prevented, thereby improving the resolving power of the range and bearing. Also, since the scattered light and the diffracted light are prevented from being incident on the light receiver 30 as stray light, the measurable distance can be extended. Therefore, even in a configuration in which the outgoing light L10 emitted from the laser light source 10 passes through the optical splitter 340 and the return light L20 is reflected off the optical splitter 340, the resolving power of the range and bearing can be improved and the measurable distance can be extended.

Also, the distance measuring apparatus 300 further includes the second aperture unit 60 disposed on the optical path from the first aperture unit 50 to the optical splitter 340. The second opening 60a of the second aperture unit 60 is larger than the first opening 50a of the first aperture unit 50. Accordingly, the second aperture unit 60 can block the diffracted light, which is generated when the outgoing light L10 passes through the first opening 50a, of the outgoing light L10.

FIG. 8 is a diagram showing a first aperture unit 351 of the distance measuring apparatus 300 according to the second modification of the embodiment as another example, as seen in the Z-axis direction. As shown in FIG. 8, the first aperture unit 351 includes a light transmitting portion 350a as a light-passing portion, a light blocker 350b, and a boundary area 350c as a first boundary area.

The light transmitting portion 350a transmits part, which includes the center light flux, of the outgoing light L10. The shape of the light transmitting portion 350a as seen in the Z-axis direction is, for example, circular. The light blocker 350b is disposed outside the light transmitting portion 350a and blocks peripheral rays of the outgoing light L10. The light blocker 350b is, for example, a metal film deposited on transparent glass.

The boundary area 351c is disposed between the light transmitting portion 350a and the light blocker 350b. The boundary area 351c is, for example, circular. The transmittance of the outgoing light L10 in the boundary area 351c becomes higher as it approaches the light transmitting portion 350a and lower as it approaches the light blocker 350b.

Thus, in the boundary area 351c of the first aperture unit 351, the transmittance has a gradient. Accordingly, when the outgoing light L10 emitted from the laser light source 10 passes through the light transmitting portion 350a of the first aperture unit 351, scattering and diffraction can be prevented. It is preferable that the width of the boundary area 351c be about 5% of the diameter of the light transmitting portion 350a. It should be noted that the second aperture unit 60 may include a second boundary area disposed between the light transmitting portion and the light blocker, and the transmittance of the second boundary area may increase as it approaches the light transmitting portion.

FIG. 9 is a diagram showing a first aperture unit 352 of the distance measuring apparatus 300 according to the second modification of the embodiment as still another example, as seen in the Z-axis direction. As shown in FIG. 9, the first aperture unit 352 includes the opening 50a and the light blocker 352b disposed outside the opening 50a.

The first aperture unit 352 includes a plurality of projections 352d arranged on an inner surface 352s surrounding the opening 50a. Each projection 352d narrows as it approaches the opening 50a. In an example shown in FIG. 9, the inner surface 352s is serrated. Accordingly, when the outgoing light L10 emitted from the laser light source 10 passes through the first aperture unit 352, scattering and diffraction on the inner surface 352s surrounding the opening 50a can be prevented. It should be noted that projections, each of which narrows as it approaches the opening 60a, may be arranged on the inner surface surrounding the opening 60a of the second aperture unit 60.

### Advantages of Second Modification of Embodiment

According to a second modification of the embodiment described above, the distance measuring apparatus 300 includes the first aperture unit 50 disposed on the optical path, from the laser light source 10 to the transmitting portion 340b of the optical splitter 340, of the outgoing light L10, and the distance measuring apparatus 300 makes the diameter of the outgoing light L10 small. Accordingly, scattering and diffraction for the case where the outgoing light L10 is incident on the optical splitter 340 is prevented, thereby improving the resolving power of the range and bearing. Also, since scattered light and diffracted light of the outgoing light L10 are prevented from being incident on the light receiver 30 as stray light, the measurable distance can be extended. Therefore, the distance measuring apparatus 300 can improve the resolving power of the range and bearing and extend the measurable distance.

Also, according to the second modification of the embodiment, the first aperture unit 351 includes the boundary area 351c disposed between the light transmitting portion 350a and the light blocker 350b, and the transmittance of the outgoing light L10 in the boundary area 351c increases as it approaches the light transmitting portion 350a. Accordingly, scattering and diffraction can be prevented for the case where the outgoing light L10 emitted from the laser light source 10 passes through the light transmitting portion 350a of the first aperture unit 351. Thus, the distance measuring apparatus 300 can further improve the resolving power of the range and bearing and further extend the measurable distance.

Also, according to the second modification of the embodiment, the projections 352d are arranged on the inner surface 352s surrounding the opening 50a of the first aperture unit 352. Each projection 352d narrows as it approaches the opening 50a. Accordingly, when the outgoing light L10 emitted from the laser light source 10 passes through the first aperture unit 352, scattering and diffraction on the inner surface 352s can be prevented. Thus, the distance measuring apparatus 300 can further improve the resolving power of the range and bearing and further extend the measurable distance.

### Third Modification of Embodiment

FIG. 10 is a configuration diagram showing a schematic configuration of a distance measuring apparatus 400 according to a third modification of the embodiment. In FIG. 10, each component identical or corresponding to a component shown in FIG. 5 is assigned the same reference sign as those in FIG. 5. The distance measuring apparatus 400 according to the third modification of the embodiment differs in each shape of a first aperture unit 450 and a second aperture unit 460 from the distance measuring apparatus 200 according to the first modification of the embodiment. With respect to the other points, the distance measuring apparatus 400 according to the third modification of the embodiment is the same as the distance measuring apparatus 200 according to the first modification of the embodiment. For that reason, the description hereafter also refers to FIG. 4.

As shown in FIG. 10, the distance measuring apparatus 400 includes the laser light source 10, the scanning mirror 20 (see, FIG. 4), the light receiver 30 (see, FIG. 4), the optical splitter 40, the first aperture unit 450, and the second aperture unit 460.

The first aperture unit 450 is a tabular member that becomes thinner toward the first opening 50a. Accordingly, when the outgoing light L10 emitted from the laser light source 10 passes through the first opening 50a, scattering and diffraction on the inner surface surrounding the first opening 50a can be suppressed. In an example shown in FIG. 10, the surface 450d on the laser light source 10 side of the first aperture unit 450 is inclined in a direction away from the laser light source 10 as it approaches the first opening 50a.

The second aperture unit 460 is a tabular member that becomes thinner toward the second opening 60a. Accordingly, when the outgoing light L10 that has passed through the first opening 50a passes through the second opening 60a, scattering and diffraction on the inner surface surrounding the second opening 60a can be suppressed. In an example shown in FIG. 10, a surface 460d on the first aperture unit 450 side of the second aperture unit 460 is inclined in a direction away from the first aperture unit 450 as it approaches the second opening 60a. It should be noted that at least one of the first aperture unit 450 or the second aperture unit 460 may be thinner as it approaches its opening.

### Advantages of Third Modification of the Embodiment

According to the third modification of the embodiment described above, the first aperture unit 450 is a tabular member that becomes thinner toward the first opening 50a. Accordingly, when the outgoing light L10 emitted from the laser light source 10 passes through the first opening 50a, scattering and diffraction on the inner surface surrounding the first opening 50a can be suppressed. Thus, the distance measuring apparatus 400 can improve the resolving power of the range and bearing and extend the measurable distance.

Also, according to the third modification of the embodiment, the second aperture unit 460 is a tabular member that becomes thinner toward the second opening 60a. Accordingly, when the outgoing light L10 that has passed through the first opening 50a passes through the second opening 60a, scattering and diffraction on the inner surface surrounding the second opening 60a can be suppressed. Thus, the distance measuring apparatus 400 can further improve the resolving power of the range and bearing and further extend the measurable distance.

### Fourth Modification of Embodiment

FIG. 11 is a configuration diagram showing a schematic configuration of a distance measuring apparatus 500 according to fourth modification of the embodiment. In FIG. 11, each component identical or corresponding to a component shown in FIG. 5 is assigned the same reference sign as those in FIG. 5. The distance measuring apparatus 500 according to the fourth modification of the embodiment differs in each shape of the first aperture unit 450 and the second aperture unit 460 from the distance measuring apparatus 200 according to the first modification of the embodiment. With respect to the other points, the distance measuring apparatus 500 according to the fourth modification of the embodiment is the same as the distance measuring apparatus 200 according to the first modification of the embodiment. For that reason, the description hereafter also refers to FIG. 4.

As shown in FIG. 11, the distance measuring apparatus 500 includes the laser light source 10, the scanning mirror 20 (see, FIG. 4), the light receiver 30 (see, FIG. 4), the optical splitter 40, the first aperture unit 550, the second aperture unit 560, a first aperture holder 571, and a second aperture holder 572.

The first aperture unit 550 includes a plate 551 as a first plate and a plate 552 as a second plate. The plate 551 is held by the first aperture holder 571. The plate 552 is held by the second aperture holder 572. It should be noted that the first aperture holder 571 and the second aperture holder 572 may be integrally formed with a component holding other optical component such as a lens or the optical splitter 40.

The plates 551 and 552 are disposed with the outgoing light L10 in between. Part, which includes the center light flux, of the outgoing light L10 passes through the opening 50a, which is a gap formed between the plate 551 and the plate 552. Also, the neighboring rays L12, which travel through positions away from the optical axis C1, of the outgoing light L10 are blocked by the plate 551 and the plate 552. Accordingly, the first aperture unit 550 can make the diameter of the outgoing light L10 traveling from the laser light source 10 to the optical splitter 40 small. Therefore, the distance measuring apparatus 500 can improve the resolving power of the range and bearing and extend the measurable distance.

In order to dispose an aperture unit precisely with respect to the optical axis C1, it is contemplated to integrally form the aperture unit with a component (i.e., other holding structure) holding other optical component such as a lens or the optical splitter 40. However, if an aperture unit is formed integrally with other holding structure, it is difficult to process and consequently it is difficult to form an opening in the aperture unit. Also, if an aperture unit, as a separate component, including an opening is fixed to an aperture holder by screws or the like, the accuracy of positioning the aperture unit is reduced. In the fourth modification of the embodiment, portions of the first aperture unit 550 that blocks the neighboring rays L12 of the outgoing light L10 are divided. Specifically, the plate 552 is shifted in the outgoing direction (i.e., Z-axis direction) of the outgoing light L10 with respect to the plate 551. Accordingly, the accuracy of positioning the first aperture unit 550 is enhanced and the occurrence of stray light can be prevented. In addition, the fourth modification of the embodiment makes it easy to form the opening 50a in the first aperture unit 550.

The second aperture unit 560 includes a plate 561 as a first plate and a plate 562 as a second plate. The plate 561 is held by the first aperture holder 571. The plate 562 is held by the second aperture holder 572.

The plates 561 and 562 are disposed with the outgoing light L10 in between. The outgoing light L10 has passed through the first aperture unit 550 passes through the opening 60a, which is a gap formed between the plates 561 and 562. The opening 60a is larger than the opening 50a. Accordingly, diffracted light of the outgoing light L10 caused by passing through the opening 50a can be blocked by the plates 561 and 562.

Thus, in the fourth modification of the embodiment, part of the second aperture unit 560 that blocks diffracted light of the outgoing light L10 is also divided. Specifically, the plate 562 is shifted in the outgoing direction of the outgoing light L10 (i.e., in the Z-axis direction) with respect to the plate 561. Accordingly, the accuracy of positioning the second aperture unit 560 is enhanced and the occurrence of stray light can be prevented. In addition, the fourth modification of the embodiment makes it easy to form the opening 60a in the second aperture unit 560.

FIG. 12 is a diagram showing a first aperture unit 550A of the distance measuring apparatus 400 according to the fourth modification of the embodiment as another example, as seen in the Z-axis direction. As shown in FIG. 12, the first aperture unit 550A includes a first plate 551A and a second plate 552A shifted in the +Z-axis direction with respect to the first plate 551A.

The second plate 552A includes a penetration portion 550e penetrating in the Z-axis direction. The first plate 551A and a part of the penetration portion 550e overlap each other as seen in the Z-axis direction. Thus, in an example shown in FIG. 12, a part of the penetration portion 550e is blocked by the first plate 551A. A part of the outgoing light L10 emitted from the laser light source 10 passes through the area, which is not blocked by the first plate 551A, of the penetration portion 550e. Accordingly, the first aperture unit 550A can make the diameter of the outgoing light L10 small. Thus, since scattering and diffraction for the case where the outgoing light L10 is incident on the optical splitter 40 are prevented, that is, the occurrence of stray light is prevented, the resolving power of the range and bearing can be improved and the measurable distance can be extended.

Also, in an example shown in FIG. 12, part of the first aperture unit 550A that blocks the neighboring rays L12 of the outgoing light L10 is divided. Accordingly, the accuracy of positioning the first aperture unit 550A can be enhanced and the occurrence of stray light can be prevented. It should be noted that the second aperture unit 560 may have the same configuration as the first aperture unit 550A shown in FIG. 12.

### Advantages of Fourth Modification of Embodiment

According to the fourth modification of the embodiment described above, the first aperture unit 550 includes the plate 551 and the plate 552 shifted in the outgoing direction of the outgoing light L10 with respect to the plate 551, and the outgoing light L10, which travels from the laser light source 10 to the optical splitter 340, passes between the plate 551 and the plate 552. Accordingly, the accuracy of positioning the first aperture unit 550 can be enhanced and the occurrence of stray light can be prevented.

Also, according to the fourth modification of the embodiment, the second aperture unit 560 includes the plate 561 and the plate 562 shifted in the outgoing direction of the outgoing light L10 with respect to the plate 561, and the outgoing light L10, which travels from the first aperture unit 550 to the optical splitter 340, passes between the plate 561 and the plate 562. Accordingly, the accuracy of positioning the second aperture unit 560 can be enhanced and the occurrence of stray light can be prevented.

Also, according to the fourth modification of the embodiment, the first aperture unit 550A includes the first plate 551A and the second plate 552A shifted in the outgoing direction of the outgoing light L10 with respect to the first plate 551A. The second plate 552A includes the penetration portion 550e through which the outgoing light L10 passes, and the first plate 551A and a part of the penetration portion 550e overlap each other as seen in the outgoing direction of the outgoing light L10. Accordingly, the accuracy of positioning the first aperture unit 550A can be enhanced and the occurrence of stray light can be prevented.

### DESCRIPTION OF REFERENCE CHARACTERS

10 laser light source, 11 light source, 12 transmitting optic, 12a convex lens, 20 scanning mirror, 20a reflecting surface, 21 22 rotation axis, 30 light receiver, 31 condensing optic, 32 light receiving element, 40 340 optical splitter, 40a 340a reflecting portion, 40b 340b transmitting portion, 50 351 352 450 550 550A first aperture unit, 50a 550a first opening, 50b 350b 352b light blocker, 60 460 560 second aperture unit, 60a 560a second opening, 60b second light blocker, 90 object, 100 200 300 400 distance measuring apparatus, 101 optical scanner, 102 computer, 102a controller, 102b arithmetic unit, 102c storage unit, 103 housing, 103a transparent window, 110 optical transmission system, 350a light transmitting portion, 351c boundary area, 352d projection, 352s inner surface, 450d 460d surface, 550c 550e penetration portion, 551 551A 552 552A 561 562 plate, 571 first aperture holder, 572 second aperture holder, A1 A2 opening width, Ah diameter, C1 C3 optical axis, D1 D2 D3 light intensity distribution, L1 laser light, L10 outgoing light, L11 center light flux, L12 neighboring rays, L20 return light.

1. A distance measuring apparatus to detect return light reflected off or scattered by an object and measure a distance to the object, comprising:
a laser light source;
an optical scanning unit to scan with outgoing light emitted from the laser light source;
a light receiving unit to detect the return light reflected off the optical scanning unit, the return light being reflected off or scattered by the object irradiated with the outgoing light from the optical scanning unit;
a light-path guiding unit to direct the outgoing light emitted from the laser light source toward the optical scanning unit;
a first aperture unit to make a diameter of the outgoing light small and disposed on an optical path, from the laser light source to the light-path guiding unit, of the outgoing light, the first aperture unit including a first light-passing portion to allow part, including center light flux, of the outgoing light to pass, and a first light blocker disposed outside the first light-passing portion; and
a second aperture unit including a second light-passing portion and disposed on an optical path, from the first aperture unit to the light-path guiding unit, of the outgoing light, the second light-passing portion being larger than the first light-passing portion.

2. The distance measuring apparatus according to claim 1, wherein the return light reflected off the optical scanning unit passes through the light-path guiding unit and is then incident on the light receiving unit.

3. The distance measuring apparatus according to claim 1, wherein the return light reflected off the optical scanning unit is reflected off the light-path guiding unit and is then incident on the light receiving unit.

4. The distance measuring apparatus according to claim 1, wherein the return light reflected off the optical scanning unit passes through an outside of the light-path guiding unit and is then incident on the light receiving unit.

5. (canceled)

6. The distance measuring apparatus according to claim 1, wherein
the first aperture unit further includes a first boundary area disposed between the first light-passing portion and the first light blocker, and
transmittance of the outgoing light in the first boundary area increases as it approaches the first light-passing portion.

7. The distance measuring apparatus according to claim 1, wherein the first light-passing portion is a first opening that is smaller than the diameter of the outgoing light.

8.-9. (canceled)

10. The distance measuring apparatus according to claim 1, wherein projections are arranged on an inner surface surrounding an opening that is at least one of the first opening or the second opening, each projection narrowing as it approaching the opening.

11. The distance measuring apparatus according to claim 1, wherein a distance between the first aperture unit and the second aperture unit is 1.0 mm or more.

12. The distance measuring apparatus according to claim 1, wherein a thickness of at least one of the first aperture unit or the second aperture unit in an outgoing direction of the outgoing light is 2.0 mm or more.

13. The distance measuring apparatus according to claim 1, wherein
the second aperture unit further includes
a second light blocker disposed outside the second light-passing portion, and
a second boundary area disposed between the second light-passing portion and the second light blocker, wherein
transmittance of the outgoing light in the second boundary area increases as it approaches the second light-passing portion.

14. The distance measuring apparatus according to claim 1, wherein at least one of the first aperture unit or the second aperture unit is a tabular member that becomes thinner toward the first light-passing portion.

15. The distance measuring apparatus according to claim 1, wherein
at least one of the first aperture unit or the second aperture unit includes
a first plate, and
a second plate shifted in an outgoing direction of the outgoing light with respect to the first plate, and
the outgoing light, which travels from the laser light source to the light-path guiding unit, passes between the first plate and the second plate.

16. The distance measuring apparatus according to claim 1, wherein
at least one of the first aperture unit or the second aperture unit includes
a first plate, and
a second plate shifted in an outgoing direction of the outgoing light with respect to the first plate, wherein
the second plate includes a penetration portion through which the outgoing light passes, the outgoing light traveling from the laser light source to the light-path guiding unit, and
the first plate and a part of the penetration portion overlap each other as seen in the outgoing direction.

17. The distance measuring apparatus according to claim 1, wherein
the laser light source includes
a light source, and
an optical unit to convert laser light emitted from the light source into collimated beams and emits the collimated beams as the outgoing light.

18. The distance measuring apparatus according to claim 1, wherein
the light receiving unit includes
a light receiving element, and
a condensing lens to condense the return light reflected off the optical scanning unit and direct the return light to the light receiving element, and
the light-path guiding unit is inclined with respect to a plane perpendicular to an optical axis of the light receiving unit.

19. The distance measuring apparatus according to claim 1, wherein the second aperture unit is disposed at a position for the case where a light intensity of the outgoing light passing through the second aperture unit is ⅕ or less of a peak intensity of the outgoing light passing through the first aperture unit.
